(19) United States
(12) Patent Application Publication
(10) Pub. No.: US 2011/0151868 A1
(43) Pub. Date: Jun. 23, 2011

(54) METHOD OF SEARCHING FOR THE USER EQUIPMENTS IN THE SPECIFIC AREA AND MEANS FOR THE SAME

(76) Inventor: Hongguang Sun, Shanghai (CN)

(21) Appl. No.: 13/061,136

(22) PCT Filed: Aug. 26, 2008
(86) PCT No.: PCT/CN2008/001530

§ 371 Date: Feb. 26, 2011

(51) Int. Cl. H04W 4/00

(52) U.S. Cl. 455/434

(57) ABSTRACT

The present invention aims to provide a technical solution for the caller can call the user equipments in the specific area without knowing the numbers of the user equipments first. A querying device sends a first querying request message to a querying response server to query the user equipments in the specific area. The querying server sends a first querying response message comprising the relevant information of the user equipments in the specific area back to the querying device. The relevant information includes the communication identifier (such as number). The caller then can communicate with the user equipment in the specific area according to the first querying response message. The present invention enhances the existing location services and provides the reversed style location service to users or customers and helps to improve the users' experiences in communication.

### FIELD OF THE INVENTION

The present invention relates to communication networks, particularly, to method and means for searching for the user equipments in the specific area.

### BACKGROUND OF THE INVENTION

The location services are popular for both 3G networks and even for legacy 2G networks now. In wireless communication networks, the location services facilitate obtaining the geographic position information of the user equipments according to communication identifier of the user equipments.

Sometimes, you may need to communicate with the people in a specified area instead of a specific number. For example, the sales men of a company are spreading around the country and the officer of the company hopes to call the sales staff close to one of the customer for a meeting; TAXI company hopes to call a driver to pick up a nearby customer in emergency; the sport host hopes to call all the reporters in the stadium immediately for an urgent issue; travelers randomly go into the mountain areas and the district administrative hopes to warn the travelers in a specific area of some kind of risk; and etc. In all these scenarios, the called number is unknown before the calling and the caller expects to get in touch with mobile devices with numbers of specific category within the specified area.

In above said scenarios, usually, the caller doesn't know the communication identifier of the user equipments, but the caller wants to communicate with the user equipments.

### SUMMARY OF THE INVENTION

For above said scenarios, the present invention provides a technical solution for the caller can call the user equipments in the specific area without knowing the numbers of the user equipments first.

According to the first aspect of the present invention, there is provided a method for searching for the user equipments in the specific area specified by a querying device in a query-response server of communication networks, characterized by comprising the steps of: a. receiving a querying request message from said querying device, said querying request message including the information of the specific area specified by said querying device is used for searching for the user equipments located in said specific area; d. searching for the user equipments in said specific area; e. sending a querying response message to said querying device, said querying response message is used for informing said querying device of the relevant information of the user equipments located in said specific area.

According to the second aspect of the present invention, there is provided a method for obtaining the relevant information of the user equipments in the specific area from a query-response server in a querying device of communication networks, characterized by comprising the steps of: i. sending a querying request message to said querying response server, said querying request message including the information of the specific area specified by the querying device is used for searching for the user equipments located in said specific area; ii. receiving a querying response message from said querying response server, said querying response message is used for informing said querying device of the relevant information of the user equipments located in said specific area.

According to the third aspect of the present invention, there is provided a querying response means for searching for the user equipments in the specific area specified by a querying device in a query-response server of communication networks, characterized by comprising: a receiving means for receiving a querying request message from said querying device, said querying request message including the information of the specific area specified by said querying device is used for searching for the user equipments located in said specific area; a searching for means for searching for the user equipments in said specific area; a sending means for sending a querying response message to said querying device, said querying response message is used for informing said querying device of the relevant information of the user equipments located in said specific area.

According to the fourth aspect of the present invention, there is provided a query means for obtaining the relevant information of the user equipments in the specific area from a query-response server in a querying device of communication networks, characterized by comprising: a second sending means for sending a querying request message to said querying response server, said querying request message including the information of the specific area specified by the querying device is used for searching for the user equipments located in said specific area; a second receiving means for receiving a querying response message from said querying response server, said querying response message is used for informing said querying device of the relevant information of the user equipments located in said specific area.

The present invention enhances the existing location services and provides the reversed style location service to users or customers. With the aid of the present invention, the caller can call the user equipments in the specific area without knowing the numbers of the user equipments first. The technical solution of the present invention can help to improve the users' experiences in communication.

### BRIEF DESCRIPTION OF THE DRAWINGS

The present invention will be described in detail with reference to the accompanying drawings, in which identical reference numerals denote identical or like components:

FIG. 1 is a schematic view of one network topology of communication networks according to one embodiment of the present invention;

FIG. 2 is a system flowchart according to one embodiment of the present invention;

FIG. 3 is a schematic view of one network topology of communication networks according to another embodiment of the present invention;

FIG. 4 is a block diagram of a querying response means for searching for the user equipments in the specific area specified by a querying device in a query-response server of communication networks, according to one embodiment of the present invention;

FIG. 5 is a block diagram of a query means for obtaining the relevant information of the user equipments in the specific area from a query-response server in a querying device of communication networks, according to one embodiment of the present invention.

### DESCRIPTION OF THE PREFERRED EMBODIMENTS

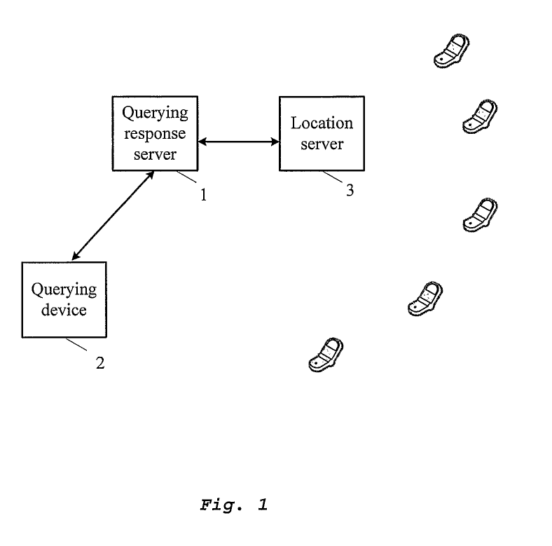

Referring to FIG. 1, there is a network topology including a querying response server 1, a querying device 2, a location server 3 and many user equipments. The querying response server 1 receives a first querying request message for a querying device 2, the querying request message including the information of the specific area specified by the querying device 2 is used for searching for the user equipments located in said specific area. The querying response server 1 get the geographic information of all the user equipments from the location server 3 and sends the relevant information of the user equipments in the specific area specified by the querying device 2 to the querying device 2. It should be pointed out that the user equipment are various, for example, mobile phones, telephone, PHS (Personal Handyphone System) user terminals, PDA (Personal Digital Assistant) etc.

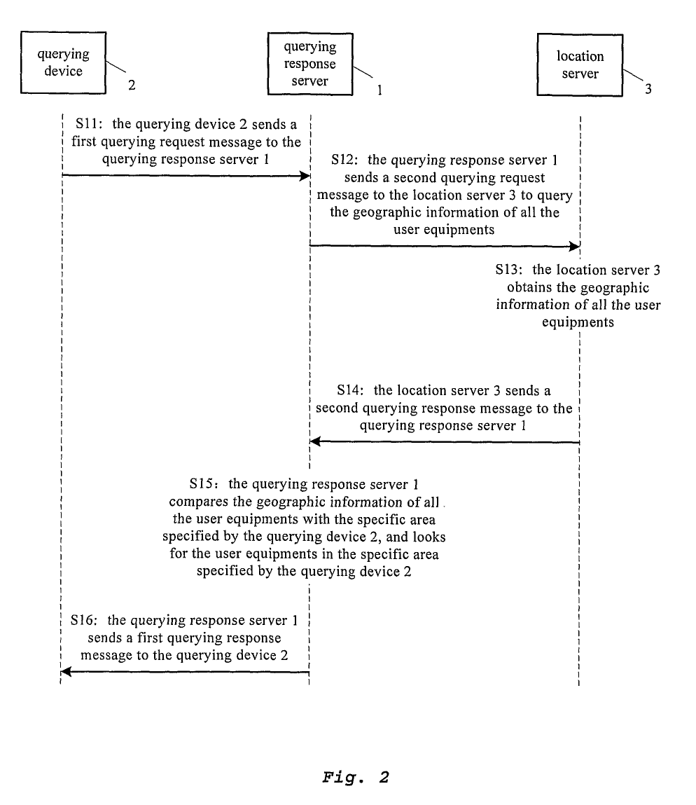

Referring to FIG. 2, there is a system flowchart of the process of the query-response. The detail of the process will be explained below in conjunction with FIG. 1 and FIG. 2.

Firstly, in step S11, the querying device 2 sends a first querying request message to the querying response server 1, the first querying request message is used for searching for the user equipments in the specific area specified by the querying device 2. The querying device 2 may be one of the user equipments, or other communication devices, such as a computer, PDA etc. The way that the querying device 2 communicates with the querying response server is not limited, either wireless (WiFi, WiMAX etc.) or wired line (CAT 5 twisted-pair, fiber etc.). The specific area can be expressed by longitude and dimensionality or by the name of streets, etc. One possible way of implementation of sending the first querying request message is as below: a querying client software is installed in the querying device; the user open the software, the software provides the user with many maps, the user chooses one map and opens it, choose some area and then click “OK” and the querying device 2 sends the first querying request message to the querying response server 1.

The querying response server receives the first querying request message from the querying device 2. Then, in step S1, the querying response server 1 sends a second querying request message to the location server 3 to query the geographic information of all the user equipments. Of course, if all the user equipments are fixed, the geographic information of all the user equipments can be pre-saved in the querying response server 1. The querying response server 1 can determine which user equipment is in the specific area specified by the querying device 2 according to the pre-saved geographic information of all the user equipments without sending the second querying response message to the location server 3. Of course, if the user equipment is fixed, it doesn't need to support locating functionality.

The location server 3 receives the second querying request message from the querying response server 1. Then in step S13, the location server 3 obtains the geographic information of all the user equipments; in step S14, the location server 3 sends a second querying response message to the querying response server 1, the second querying response message is used for sending the geographic information of all the user equipments to the querying response server 1. Of course, each of the user equipment should support location functionality. For example, the user equipment obtains its geographic information via GPS navigating system and reports its geographic information to the location server 3. Specifically, the user equipment how to get its geographic information via GPS navigating system and how to report its geographic information to the location server 3 should be the common knowledge for those skilled in the art.

The querying response server 1 receives the second querying response message from the location server 3. Then in step S15, the querying response server 1 compares the geographic information of all the user equipments with the specific area specified by the querying device 2, and searches for the user equipments in the specific area specified by the querying device 2. In step S16, the querying response server 1 sends a first querying response message to the querying device 2, the first querying response message is used for sending the relevant information of the user equipments in the specific area specified by the querying device 2 to the querying device 2. The relevant information of the user equipment includes communication identifier (e.g. phone number) of the user equipment, may also includes the flag used for indicating if the user equipment or the user is busy.

Of course, due to the mobility characteristics of the user equipments, there may be none of the user equipments in the specific area specified by the querying device 2. Then, the querying response server 1 sends a first querying response message to the querying device 2 for indicating no user equipment is in the specific area specified by the querying device 2. The querying device 2 can choose a wider area to query again.

After the querying device 2 obtaining the relevant information of the user equipments in the specific area specified by itself, if the querying device 2 has the functionality of communicating with the user equipments, it can communicate with one or all of the user equipments in the specific area. If the querying device 2 doesn't support the functionality of communicating with the user equipments, the user can use other communication device that supports the functionality of communicating with the user equipments to communicate with the user equipments. For example, the user uses a computer to query the mobile phones in Mount Everest, then uses a mobile phone or a telephone to communicate with one or all of the mobile phones in Mount Everest.

As one changing embodiment of the above embodiment, in step S12, the querying response server 1 can send the information of the specific area specified by the querying device 2. After the location server 3 obtaining the geographic information of all the user equipments, the location server 3 compares the geographic information of all the user equipments with the specific area specified by the querying device 2, and searches for the user equipments in the specific area specified by the querying device 2, i.e. the location, server executes step S15 which is executed by the querying response server 1 in the above embodiment. Then in step S14, the location server 3 sends a first response message, which includes the relevant information of one or more user equipments in the specific area specified by the querying device 2, to the querying response server 1. The advantage of this changing embodiment is the data flow between the querying response server 1 and the location server 3 is reduced, and the disadvantage is the existing location server 3 need to be updated to include the compare functionality in step S15.

If the querying response server 1 includes the functionality of the location server 3, it doesn't need to execute S12 and S14.

Alternatively, the first querying request message may further comprises a group identifier (group ID), and the first querying request message is used for searching for the user equipments belonging to the group identified by said group ID located in said specific area specified by the querying device 2. For example, China Mobile provides a mobile group service, the mobile phone of each employee of an enterprise belong to a mobile group which has a general mobile phone number. The general mobile phone number is a group ID. Of course, in the situation of the first querying request message comprising a group ID, the mapping relationship between the group IDs and its member user equipments should be pre-saved in the querying response server 1.

After receiving the first querying request message comprising an group ID, the querying response server 1 gets the member user equipments of the group ID according the pre-saved mapping relationship between the group IDs and its member user equipments, then, in step S12, sends a second querying request message, which is used for searching for the user equipments belonging to the group ID comprised in the first querying request message, to the location server 3.

After receiving the second first querying request message, in step S13, the location server 3 gets the geographic information of the user equipments belonging to the group ID, and in step S14, sends a second querying response message comprising the geographic information of the user equipments belonging to the group ID to the querying response server 1.

After receiving the second querying response message, in step S15, the querying response server 1 compares the geographic information of the user equipments belonging to the group ID with the specific area specified by the querying device 2, and determines which user equipment locates. In step S16, the querying response server 1 sends a first querying response message comprising the relevant information of the user equipments belonging to the group ID locating in the specific area specified by the querying device 2 to the querying device 2.

Preferably, the users don't want to be disturbed by irrelevant persons. The first querying request message sent by the querying device 2 may comprise authentication information for authenticating the first querying request message. The authentication information includes a predetermined password. If the user equipments are divided into many groups, the authentication information may be a predetermined password corresponding to each group, i.e. each group has its own predetermined password. After receiving the first querying request message from the querying device 2, the querying response server 1 authenticates the first querying request message firstly according to the authentication information comprised in the first querying request message. If authentication is successful, the querying response server 1 executes step S12 and following steps. Authentication may be executed either by the querying response server 1 or by a special authentication server. If authentication is failed, the querying response server 1 sends a querying response message indicating authentication fail to the querying device 2.

It should be pointed out that the method of the present invention can be applied to various communication networks, e.g. 3G/IMS, GSM, PHS, even PSTN etc.

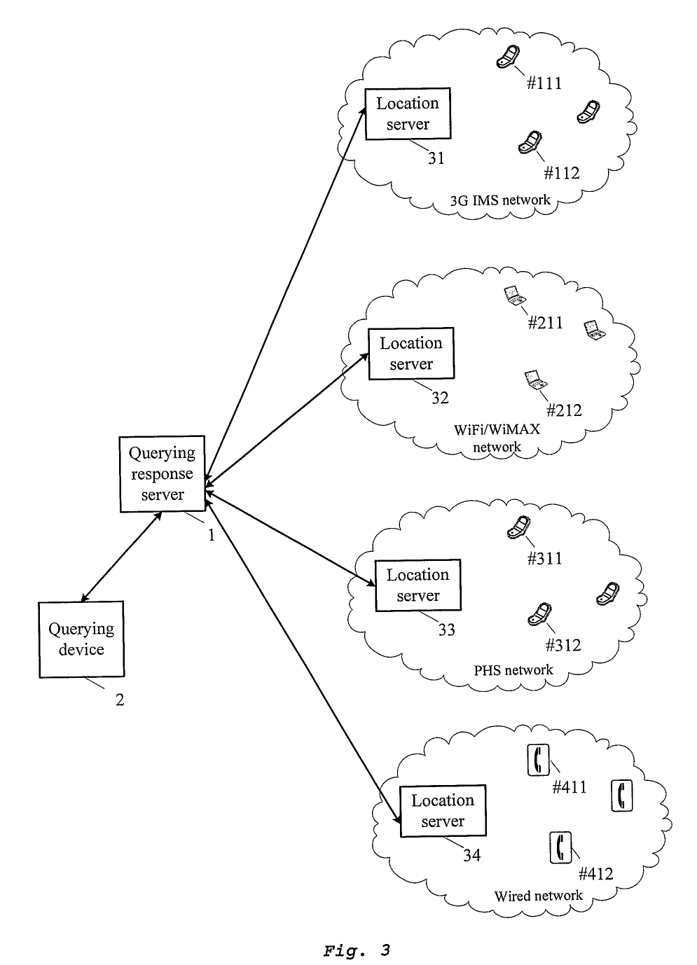

It should be pointed out that the method of the present invention can be applied to various communication networks at the same time, as illustrated by FIG. 3. The querying device 2 can obtain the relevant information of the user equipments applying different communication protocols in the specific area specified by it from the querying response server 1. As shown in FIG. 3, the querying response server 1 can communicate with the location server 31 in the 3G/IMS communication network, the location server 32 in the WiFi/WiMAX communication network, the location server 33 in the PHS communication network, the location server 34 in the wired communication network, to get the geographic information of the user equipments. Specifically, some employees of one express delivery company use 3G mobile phone, some employees of the express delivery company use WiMAX mobile phone, some employees of the express delivery company use PHS mobile phone. The express delivery company has many branches using telephones distributed indifferent areas of the city. Suppose that the group ID of the express delivery company is GF1, and the mobile phone numbers of all the employees of the express delivery company and the telephone numbers of all the branches of the express delivery company are pre-saved in the querying response server 1. The ID of the location server corresponding to each mobile phone number or each telephone number is also pre-saved in the querying response server 1. One possible form of is shown in table 1.

TABLE 1
the mapping relationship among the group IDs, the
locatio servers and the mobile phone numbers/telephone numbers

| | | |
|---|---|---|
| GF1 | Location Server 31 | #111, #112, . . . , #11n |
| | Location Server 32 | #121, #122, . . . , #12n |
| | Location Server 33 | #131, #132, . . . , #13n |
| | Location Server 34 | #141, #142, . . . , #14n |
| . . . | . . . | . . . |
| GFm | Location Server 31 | #m11, #m12, . . . , #m1n |
| | Location Server 32 | #m21, #m22, . . . , #m2n |
| | Location Server 33 | #m31, #m32, . . . , #m3n |
| | Location Server 34 | #m41, #m42, . . . , #m4n |

Suppose the group ID of the above said express delivery company is GF1. Two employees use 3G/IMS mobile phones with ID #111, #112 respectively. Two employees use WiMAX mobile phones with ID #121, #122 respectively. Two employees use PHS mobile phones with ID #131, #132 respectively. Two branches use telephones with ID #141, #142 respectively.

Suppose the operator of the express delivery company receives a call from a client locating in the first street of the city. The client wants the employee of the express delivery company to come to his place to take a mail. The operator uses the querying device 2, such as a computer, to send a first querying request message to the querying response server 1 to get the ID(s) of the mobile phone(s)/telephone(s) of the employees/branches of the express delivery company which locate within one kilometer around the first street. The first querying request message comprises the group ID. Preferably, the first querying request message may comprise a password for authentication of the first querying request message.

After receiving the first querying request message from the querying device 2, the querying response server 1 gets IDs of the member user equipments of the express delivery company according to the group ID comprised in the first querying request message and table 1. According to Table 1, the querying response server 1 sends a second querying request message to the location server 31 to query the geographic information of the member user equipments #111, #112; sends a second querying request message to the location server 32 to query the geographic information of the member user equipments #121, #122; sends a second querying request message to the location server 33 to query the geographic information of the member user equipments #131, #132; sends a second querying request message to the location server 34 to query the geographic information of the member user equipments #141, #142.

Then, location server 31 sends a second querying response message comprising the geographic information of the member user equipments #111, #112 to the querying response server 1. Location server 32 sends a second querying response message comprising the geographic information of the member user equipments #121, #122 to the querying response server 1. Location server 33 sends a second querying response message comprising the geographic information of the member user equipments #131, #132 to the querying response server 1. Location server 34 sends a second querying response message comprising the geographic information of the member user equipments #141, #142 to the querying response server 1.

Then, the querying response server 1 compares the geographic information of all the user equipments with the specific area specified by the querying device 2, and searches for the user equipments in the specific area specified by the querying device 2. Then, the querying response server 1 sends a first querying response message to the querying device 2, the first querying response message is used for sending the relevant information of the user equipments in the specific area specified by the querying device 2.

It should be pointed out that due to each location server locates in different communication network, and the querying response server 1 locates in another different communication network. For example, the querying response server 1 locates in the computer networks applying TCP/IP protocols. So, there should be an protocol-translator between the querying response server 1 and each of the location server. Specifically, how to do protocol translation is the common knowledge to those skilled in the art, the present invention doesn't need to describe any more.

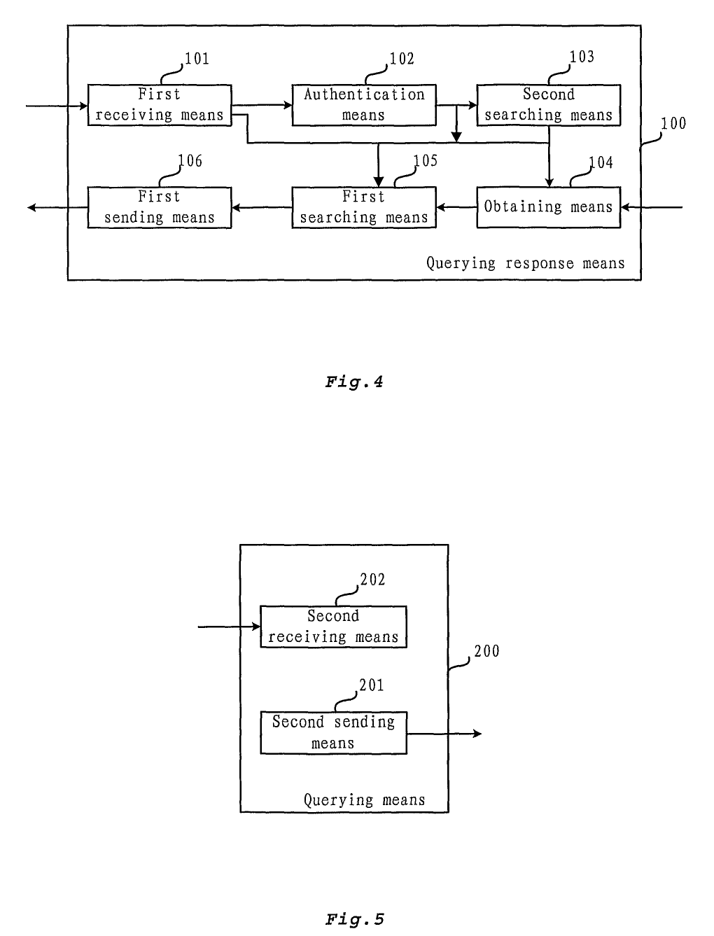

FIG. 4 shows a block diagram of a querying response means 100 for searching for the user equipments in the specific area specified by the querying device 2 in the query-response server 1 of communication networks, according to one embodiment of the present invention.

The querying response means 100 comprises a first receiving means 101, an authentication means 102, a second searching for means 103, an obtaining means 104, a first searching for means 105, a first sending means 106. For simplicity, FIG. 4 also shows many optional means in many preferred embodiments. Those skilled in the art should understand that only the first receiving means 101, the first searching means 105 and the first sending means 106 are necessary means for implementation of the present invention, other means are optional.

The third aspect of the present invention will be described referring to FIG. 4, in conjunction with FIG. 1.

At first, the first receiving means 101 receives a first querying request message from the querying device 2. The first querying request message is used for searching for the user equipments in the specific area specified by the querying device 2.

Then, the first searching means 105 searches for the user equipments in the specific area according to the specific area information comprised in the first querying request message. If all the user equipments are fixed, the geographic information of all the user equipments can be pre-saved in the querying response server 1. The first searching means 105 can determine which user equipment is in the specific area specified by the querying device 2 according to the pre-saved geographic information of all the user equipments. If the user equipments are mobile equipments, then the obtaining means 104 sends a second querying request message to the location server 3 (or the location module in the querying response server 1) to query the geographic information of all the user equipments. Then, the obtaining means 104 receives a second querying response message comprising the geographic information of all the user equipments from location server 3 (or the location module in the querying response server 1).

If the user equipments are distributed in different communication networks, the obtaining means 104 gets the geographic information of different user equipments from different location server, as shown in FIG. 2.

Then the first searching means 105 searches for the user equipments in the specific area specified by the querying device 2 according to the geographic information of all the user equipments.

At last, the first sending means 105 sends a first querying response message to the querying device 2, the first querying response message is used for sending the relevant information of the user equipments in the specific area specified by the querying device 2 to the querying device 2. The relevant information of the user equipment includes communication identifier (e.g. phone number) of the user equipment, can also includes the flag used for indicating if the user equipment or the user is busy.

Of course, due to the mobility characteristics of the user equipments, there may be none of the user equipments in the specific area specified by the querying device 2. Then, the first sending means 106 sends a first querying response message to the querying device 2 for indicating no user equipment is in the specific area specified by the querying device 2. The querying device 2 can choose a wider area to query again.

Preferably, the first querying request message may further comprises a group identifier (group ID), and the first querying request message is used for searching for the user equipments belonging to the group identified by said group ID located in said specific area specified by the querying device 2. After the first receiving means 101 receiving the first querying request message, the second searching for means 103 searches for the member user equipments belonging to the group ID according to the group ID comprised in the first querying request message and the pre-saved mapping relationship between the group IDs and the communication IDs of the user equipments. Then the obtaining means 104 and the first searching means 105 execute the following procedures as described above.

Preferably, The first querying request message sent by the querying device 2 may comprise authentication information for the authenticating means 102 to authenticate the first querying request message. If authentication is successful, then the second searching for means 103, the obtaining means 104, the first searching for means 105, the first sending means 106 execute the following procedures as described above. If authentication is failed, the first sending means 106 sends a querying response message indicating authentication fail to the querying device 2.

FIG. 5 shows a block diagram of a query means 200 for obtaining the relevant information of the user equipments in the specific area from the query-response server 1 in the querying device 2 of communication networks, according to one embodiment of the present invention.

The querying response means 200 comprises a second sending means 202, a second receiving means 201.

The fourth aspect of the present invention will be described referring to FIG. 5, in conjunction with FIG. 1.

Firstly, the second sending means 201 sends a first querying request message to the querying response server 1, the first querying request message is used for searching for the user equipments in the specific area specified by the querying device 2.

Then, the second receiving means 202 receives a first querying response message from the querying response server 1, and obtains the relevant information of the user equipments in the specific area specified by the querying device 2. The relevant information of the user equipment includes communication identifier (e.g. phone number) of the user equipment, may also includes the flag used for indicating if the user equipment or the user is busy.

Preferably, the first querying request message further comprises a group ID and the first querying request message is used for searching for the user equipments belonging to the group identified by the group ID locates in said specific area, the first querying response message is used for informing the querying device 2 of the relevant information of the user equipments belonging to said group located in said specific area.

Preferably, the first querying request message sent by the second sending means 201 may comprise authentication information for the querying response server 1 to authenticate the first querying request message. If authentication is failed, the second receiving means 201 receives a querying response message indicating authentication fail from the querying response server 1.

The embodiments of the present invention have been described above. It is to be understood that the present application is not limited to the specific embodiments described previously, and various modifications or alterations can be made by those skilled in the art within the scope of the appended claims.

1. A method of searching for the user equipments in the specific area specified by a querying device in a querying response server of communication networks, characterized by comprising the steps of:
a. receiving a first querying request message from said querying device, said first querying request message including the information of the specific area specified by said querying device is used for searching for the user equipments located in said specific area;
d. searching for the user equipments in said specific area;
e. sending a first querying response message to said querying device, said first querying response message is used for informing said querying device of the relevant information of the user equipments located in said specific area.

2. The method according to claim 1, characterized in that, before said step d, further comprises the step of:
c. obtaining the geographical information of all the user equipments;
said step d further comprises the step of:
according to said geographical information of all the user equipments, searching for the user equipments in said specific area.

3. The method according to claim 2, characterized in that, said first querying request message further comprises a group ID, said first querying request message is used for searching for the user equipments belonging to the group identified by said group ID located in said specific area, wherein, before said step c, further comprises the step of:
b. searching for all user equipments belonging to said group;
wherein, said step c further comprises the step of:
obtaining the geographical information of said all the user equipments belonging to said group;
wherein, said step d further comprises the step of:
according to said geographical information of said all the user equipments belonging to said group, searching for the user equipments belonging to said group located in said specific area;
wherein, said first querying response message is used for informing said querying device of the relevant information of the user equipments belonging to said group located in said specific area.

4. The method according to claim 1, characterized in that, before said step e, further comprises the step of:
according to the authentication information included in said first querying request message, authenticating said first querying request message,
if said authentication for said first querying request message is successful, performing said step e.

5. The method according to claim 1, said user equipments include telephones and/or mobile phones and/or PDAs, said querying device includes a telephone or a mobile phone or a computer or a PDA.

6. A method of obtaining the relevant information of the user equipments in the specific area from a query-response server in a querying device of communication networks, characterized by comprising the steps of:
i. sending a first querying request message to said querying response server, said first querying request message including the information of the specific area specified by the querying device is used for searching for the user equipments located in said specific area;
ii. receiving a first querying response message from said querying response server, said first querying response message is used for informing said querying device of the relevant information of the user equipments located in said specific area.

7. The method according to claim 6, characterized in that, said first querying request message further comprises a group ID, said first querying request message is used for searching for the user equipments belonging to the group identified by said group ID located in said specific area, said first querying response message is used for informing said querying device of the relevant information of the user equipments belonging to said group located in said specific area.

8. The method according to claim 6, characterized in that, said first querying request message further comprises authentication information which is used for said querying response server to authenticate said first querying request message.

9. The method according to claim 6, characterized in that, said user equipments include telephones and/or mobile phones and/or PDAs, said querying device includes a telephone or a mobile phone or a computer or a PDA.

10. A querying response means for searching for the user equipments in the specific area specified by a querying device in a query-response server of communication networks, characterized by comprising:
a first receiving means for receiving a first querying request message from said querying device, said first querying request message including the information of the specific area specified by said querying device is used for searching for the user equipments located in said specific area;
a first searching for means for searching for the user equipments in said specific area;
a first sending means for sending a first querying response message to said querying device, said first querying response message is used for informing said querying device of the relevant information of the user equipments located in said specific area.

11. The querying response means according to claim 10, characterized in that, further comprises:
an obtaining means for obtaining the geographical information of all the user equipments;
wherein, said first searching for means is further used for:
according to said geographical information of all the user equipments, searching for the user equipments in said specific area.

12. The querying response means according to claim 11, characterized in that, said first querying request message further comprises a group ID, said first querying request message is used for searching for the user equipments belonging to the group identified by said group ID located in said specific area, wherein, further comprises:
a second searching for means for searching for all user equipments belonging to said group;
wherein, said obtaining means is further used for:
obtaining the geographical information of said all the user equipments belonging to said group;
wherein, said first searching for means is further used for:
according to said geographical information of said all the user equipments belonging to said group, searching for the user equipments belonging to said group located in said specific area;
wherein, said first querying response message is used for informing said querying device of the relevant information of the user equipments belonging to said group located in said specific area.

13. The querying response means according to claim 10, characterized in that, further comprises:
an authentication means for according to the authentication information included in said first querying request message, authenticating said first querying request message,
if said authentication for said first querying request message is successful, said sending means sends said first querying response message to said querying device.

14. (canceled)

15. A querying means for obtaining the relevant information of the user equipments in the specific area from a query-response server in a querying device of communication networks, characterized by comprising:
a second sending means for sending a first querying request message to said querying response server, said first querying request message including the information of the specific area specified by the querying device is used for searching for the user equipments located in said specific area;
a second receiving means for receiving a first querying response message from said querying response server, said first querying response message is used for informing said querying device of the relevant information of the user equipments located in said specific area.

16. The querying means according to claim 15, characterized in that, said first querying request message further comprises a group ID, said first querying request message is used for searching for the user equipments belonging to the group identified by said group ID located in said specific area, said first querying response message is used for informing said querying device of the relevant information of the user equipments belonging to said group located in said specific area.

17-18. (canceled)
